(19) United States
(12) Patent Application Publication
(10) Pub. No.: US 2010/0248065 A1
(43) Pub. Date: Sep. 30, 2010

(54) FUEL CELL REPEATER UNIT

(76) Inventors: Jean Yamanis, South Glastonbury, CT (US); Justin Hawkes, Marlborough, CT (US); Louis Chiappetta, JR., South Windsor, CT (US); Connie E. Bird, Rocky Hill, CT (US); Ellen Y. Sun, South Windsor, CT (US); Paul F. Croteau, Columbia, CT (US)

Correspondence Address: CARLSON, GASKEY & OLDS, P.C., 400 WEST MAPLE ROAD, SUITE 350, BIRMINGHAM, MI, 48009, US

(21) Appl. No.: 12/679,772

(22) PCT Filed: Oct. 22, 2008
(86) PCT No.: PCT/US08/80671

§ 371 Date: Mar. 24, 2010

(51) Int. Cl. H01M 8/24; H01M 8/04

(52) U.S. Cl. 429/457; 429/514

(57) ABSTRACT

An example fuel cell repeater includes a separator plate and a frame establishing at least a portion of a flow path that is operative to communicate fuel to or from at least one fuel cell held by the frame relative to the separator plate. The flow path has a perimeter and any fuel within the perimeter flow across the at least one fuel cell in a first direction. The separator plate, the frame, or both establish at least one conduit positioned outside the flow path perimeter. The conduit is outside of the flow path perimeter and is configured to direct flow in a second, different direction. The conduit is fluidly coupled with the flow path.

### STATEMENT REGARDING FEDERALLY SPONSORED RESEARCH

This invention was made with United States Government support under Contract No. DE-FC26-01NT41246 awarded by the Department of Energy. The United States Government may have certain rights in this invention.

### TECHNICAL FIELD

This disclosure relates generally to fuel cells and, more particularly, to repeater units that facilitate fuel cell fluid communication through a fuel cell stack assembly.

### DESCRIPTION OF RELATED ART

Fuel cell stack assemblies are well known. Some fuel cell stack assemblies include multiple repeater units arranged in a stacked relationship. The repeater units each typically include a fuel cell, such as a solid oxide fuel cell (SOFC), that has an electrolyte layer positioned between a cathode electrode layer and an anode electrode layer. Providing the SOFC with a supply of fuel and air generates electrical power in a known manner. An interconnector near the anode electrode layer and another interconnector near the cathode electrode layer electrically connect the repeater unit to an adjacent repeater unit in the stack.

As known, some fuel cell stack assemblies rely on complex arrangements for delivering supplies of fuel and air to the SOFC within each repeater unit. Adding more repeater units to the fuel cell stack assembly typically increases the size and complexity of the delivery arrangement because each repeater unit includes an SOFC requiring an evenly distributed supply of fuel and air. One example prior art arrangement includes multiple repeater units that each have a complex pattern of holes for fuel delivery and another pattern of holes for air delivery. Aligning these holes is difficult and time consuming. These arrangements also fail to uniformly distribute fuel and air to each SOFC.

What is needed is a simplified arrangement for delivering distributed supplies of fuel and air to an SOFC.

### SUMMARY

An example fuel cell repeater includes a separator plate and a frame establishing at least a portion of a flow path that is operative to communicate fuel to or from at least one fuel cell held by the frame relative to the separator plate. The flow path has a perimeter and any fuel within the perimeter flow across the at least one fuel cell in a first direction. The separator plate, the frame, or both establish at least one conduit positioned outside the flow path perimeter. The conduit is outside of the flow path perimeter and is configured to direct flow in a second, different direction. The conduit is fluidly coupled with the flow path.

An example fuel cell stack assembly includes at least one fuel cell repeater that establishes a plurality of fuel flow paths for communicating fuel to a position adjacent at least one fuel cell. A duct houses the at least one fuel cell repeater. The duct is configured to guide airflow through the at least one fuel cell repeater.

These and other features of the disclosed examples can be best understood from the following specification and drawings. The following is a brief description of the drawings.

### BRIEF DESCRIPTION OF THE DRAWINGS

FIG. 1 shows a schematic sectional view of an example fuel cell arrangement having 6 fuel cells in a 2×3 matrix configuration.

FIG. 2 shows an example fuel cell stack assembly.

FIG. 3 shows a perspective view of an example repeater unit.

FIG. 4 shows an exploded view of the FIG. 3 repeater unit.

FIG. 5 shows a sectional view through line 5-5 of FIG. 3.

FIG. 6 shows an example stack of the FIG. 3 repeater units.

FIG. 7 shows a sectional view through a portion of the FIG. 6 stack.

FIG. 8 shows a perspective view of an example fuel cell arrangement having multiple fuel cell stack assemblies.

FIG. 9 shows a top schematic view of FIG. 8 fuel cell arrangement having multiple fuel cell stack assemblies.

### DETAILED DESCRIPTION

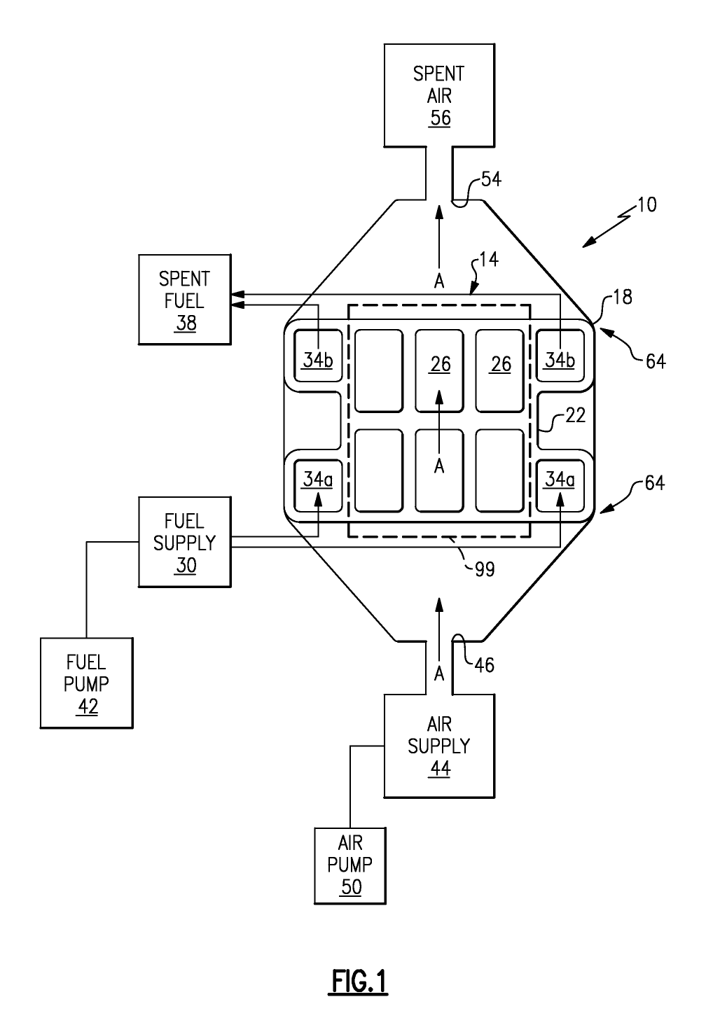

Referring to FIG. 1, an example fuel cell arrangement 10 includes a fuel cell stack assembly 14 housed within a duct 18. The fuel cell stack assembly 14 includes multiple repeater units 22. In this example, each of the repeater units 22 includes a plurality of tri-layer solid oxide fuel cells (SOFC) 26 that are arranged in a 2×3 matrix and aligned within the same plane. Other examples include different numbers of the SOFCs 26, such as a single SOFC, and different arrangements, such as a 3×3 matrix or a 4×2 matrix. The SOFCs utilize supplies of fuel and air to generate electrical power in a known manner. The M×N matrix of fuel cells in a plane, where M or N is an integer greater than 1, is referred to as the window frame design.

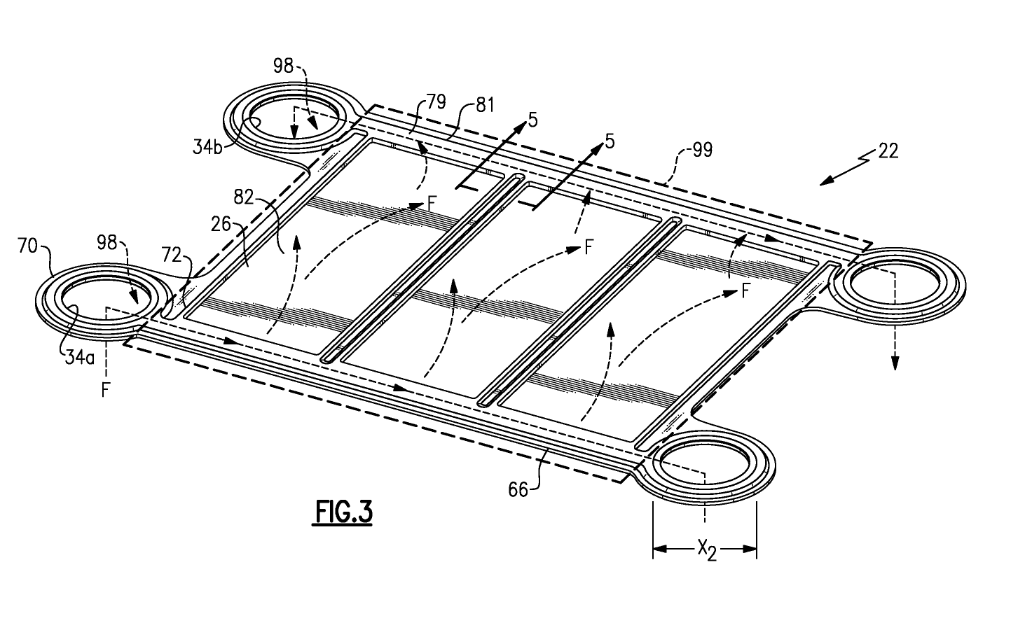

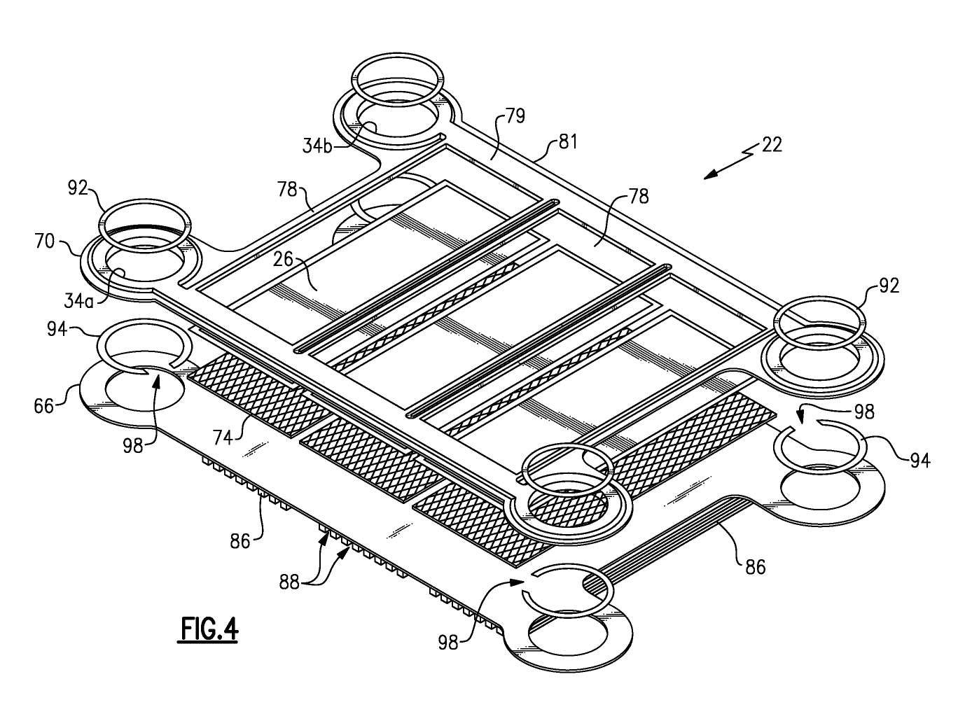

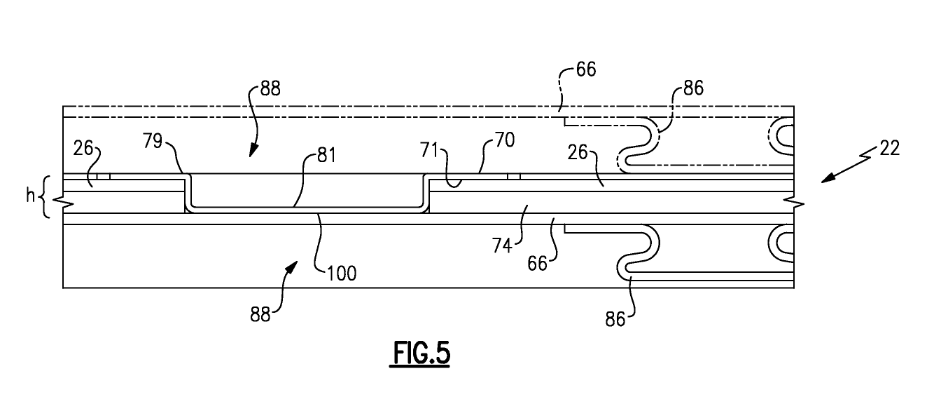

The tri-layer solid oxide fuel cells 26 discussed herein are planar and comprise the anode electrode layer, the electrolyte layer, and the cathode electrode layer. The electrolyte layer is sandwiched between the anode electrode and the cathode electrode. In all the drawings, FIG. 1-9, the anode electrode faces down.

In this example, a fuel supply reservoir 30 provides fuel that is directed through at least one conduit 34a to the repeater unit 22. The at least one conduit 34a is partially established by the repeater unit 22 in this example. Spent fuel is directed from the SOFC 26 to at least one second conduit 34b and then away from the repeater unit 22. In this example, a spent fuel reservoir 38 holds spent fuel. A fuel pump 42 facilitates moving fuel through the repeater unit 22.

In this example, an air supply 44 provides air that is directed to the duct 18 through an air inlet 46. Within the duct 18, air moves across the repeater unit 22 and leaves the duct 18 through an air outlet 54. The SOFC 26 uses the oxygen in the air for the electrochemical reaction and releases spent air, i.e., air with reduced oxygen content, through the air outlet 54. This example includes a spent air reservoir 56. An air pump 50 facilitates moving air to the duct 18 and across the repeater unit 22. In some examples, the fuel supply reservoir 30, the spent fuel reservoir 38, the air supply 44, and the spent air reservoir 56 also denote piping connections or junctions between the fuel cell arrangement 10 and a fuel cell system or power plant comprising multiples of the fuel cell arrangement 10.

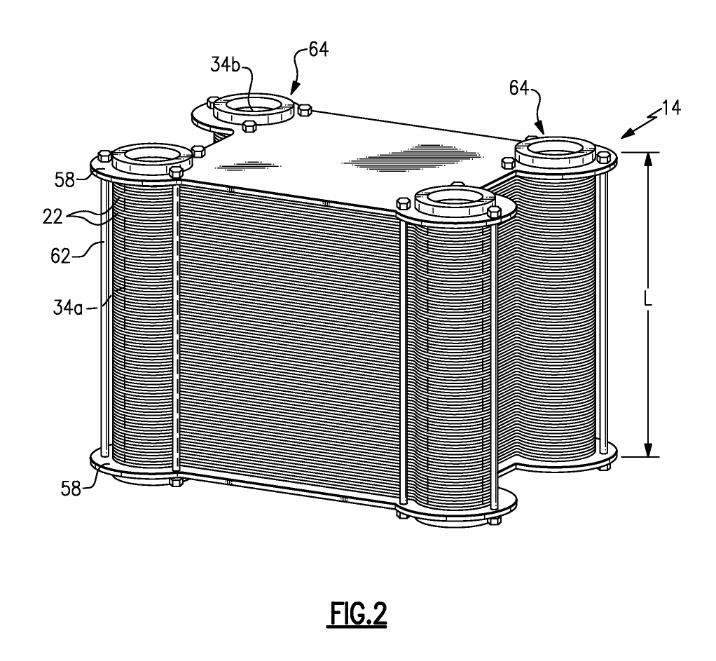

Referring to FIGS. 2-5, the fuel cell stack assembly 14 holds multiple repeater units 22 together between end plates 58. Bolts 62, or similar mechanical fasteners, secure the example components together. The corner portions 64 of the repeater units 22 and the end plates 58 establish the fuel cell conduits 34a and 34b, which have a generally circular cross-section in this example. The conduits 34a and 34b in the example of FIG. 1 have a rectangular cross section. The length L of the conduits 34a and 34b corresponds generally to the height of the fuel cell stack assembly 14. The conduits 34a and 34b will also be referred to as the primary fuel manifolds.

The example individual repeater units 22 each include a cell frame 70 secured to separator plate 66 to form a cassette-like structure. In one example, the separator plate 66 and the cell frame 70 are welded at their outer perimeters to effectively hermetically seal the fuel gas space in the fuel cell stack assembly 14.

The separator plate 66 and the cell frame 70 include holes that establish a portion of the conduits 34a and 34b in this example. Together, a plurality of the separator plates 66 and cell frames 70 establish the conduits 34 when they are in a cell stack assembly 14.

The SOFCs 26 and corresponding flat wire mesh interconnects 74, which is also referred to as the anode-side interconnect, are held between the cell frame 70 and the separator plate 66. In another example, the flat wire mesh interconnects 74 comprise corrugated expanded metal. In yet another example, the flat wire mesh interconnects 74 are replaced with dimples extending from the separator plate 66.

Each repeater unit 22 holds multiple SOFCs 26 within the same plane in this example. Openings 78 through the cell frame 70 leave a portion of the SOFCs 26 exposed. In this example, the openings 78 are larger than the cathode electrode layer of the SOFCs 26. The example openings 78 have a rectangular profile. The cell frame 70 contacts the electrolyte surface of the SOFCs 26 at a joint 71 made of glass, glass ceramics, ceramics, metal oxides, metal brazes or a combination of them.

Some portions of the cell frame 70 are spaced from the separator plate 66 to provide a fuel channel 72, which comprises a trough-like cavity extending along the front and the back of the repeater unit 22, the front being ahead of the first row of cells and the back being after the last row of cells in the repeater unit. Fuel moving within the repeater unit 22 flows within the fuel channel 72 and across the fuel cells 26. The flow channel 72 will also be referred to as the secondary fuel manifold.

In some examples, the cell frame 70 comprises a stamped piece. The equipment stamping the cell frame 70 is configured to deform the relatively planar stock material to establish the portion of the cell frame 70 that corresponds to the fuel channel 72 and accommodates the heights of the anode side interconnect 74, the fuel cell 26, the height of the bonding materials that may be used to bond the interconnect 74 to the anode electrode of the fuel cell 26, and the height of the sealing materials that are used to bond and seal the top electrolyte surface at the periphery of the fuel cell 26 to the corresponding underside surface of cell frame 70. The bonding and sealing materials are not shown in the drawings. The stamping operation moves a first portion 79 of the cell frame 70 away from a second portion 81. In this example, the amount of movement, and relative deformation, between the first portion 79 and the second portion 81 corresponds to a height h, which is the approximate sum of the heights of the SOFC 26, the anode side interconnect 74, and any bonding materials that may be bond the anode side interconnect 74 to the separator plate 66 and to the anode electrode of the SOFCs 26.

The openings 78 and the openings 34a and 34b are formed either during the stamping step or by machining after the stamping operation by any suitable and cost-effective machining operations such as milling, electron discharge machining (EDM), laser slicing. The space created between the first portion 79 and the cell frame 70 receives portions of the SOFC 26 and the anode interconnect 74. The openings 78 are smaller than the dimensions of the anode electrode and electrolyte layer, and larger than the cathode of the SOFC 26. Thus, the space created between the first portion 79 and the cell frame 70 receives the anode electrode and electrolyte layer of the SOFC 26, and the cathode of the SOFC 26 extends into or through the opening.

The second portion 81 of the cell frame 70 is then secured to the separator plate 66 by welding a continuous welding bead along the exterior perimeter of the separator plate 66 and the cell frame 70. The second portion 81 of the cell frame 70 is secured to the separator plate 66 by a sufficient number of spot welds 100 between adjacent SOFCs 26.

A seal 92 seals the interface between adjacent repeater units 22 that combine to establish the conduits 34a and 34b. In one example, each seal 92 comprises an O-ring-like structure having a V-, C-, or ∈-shaped cross-section. One side of the seal 92 is welded to the cell frame 70 in the openings 34a and 34b. The opposite side of the seal 92 is bonded to the underside of the separator plate 66 corresponding to the adjacent repeater unit 22 within the stack. This bonding is achieved by means of dielectric materials or through another set of materials and processes that ensure dielectric separation between adjacent repeater units 22. The bonding dielectric materials for sealing may be glass, glass ceramics, glass-metal composites, glass-metal oxide composites or their combination. The bonding materials may also be chosen appropriate metallic materials provided that the seal 92 or the respective area of the separator plate 66 are equipped with a dielectric skin that has adequate voltage breakdown strength to ensure dielectric isolation of the repeater units 22 in a stack. These bonding materials will also be referred to as sealing materials.

A plurality of inserts 94 that have a thickness essentially equal to the distance between the first portion 79 and the second portion 81 of the cell frame 70 are positioned between the cell frame 70 and the separator plate 66 each permit fuel flow F between the respective conduit 34a and 34b and the fuel channel 72. The inserts 94 do not seal a closed periphery and have an opening corresponding to the width of the fuel channel 72. The example inserts 94 need only be spot-welded to either the cell frame 70 or the separator plate 66 in this example so as to keep the opening of the insert 94 aligned with the fuel channel 72. The inserts 94 support the corresponding area of the cell frame 70 around the conduits 34a and 34b so that a compressive load can be applied to the seals 92 to achieve sealing around the conduits 34a and 34b and maintain the integrity of the seal 92 in a stack.

In another example, the first portion 79 of the cell frame 70 is displaced, by the stamping process for example. The displacement is of a sufficient amount that the displaced portion, and associated bonding materials, spans between the surface 79 of the cell frame 70 and the underside of the adjacent separator plate 66. The inserts 94 in such an example have the appropriate thickness to provide structural support to the sealing portion of the cell frame sheet around the conduits 34a and 34b.

In this example, the conduits 34a and 34b are positioned near corners of the openings 78, and the direction of fuel flow through the conduits 34a and 34b is perpendicular to the direction of fuel flow across the SOFCs 26. Adjusting the cross-sectional area X₂ of the conduits 34a and 34b alters characteristics of flow through the conduits 34a and 34b. The value of X₂ is chosen so as to ensure near uniform distribution of fuel to the repeater units in a stack. For example, utilizing the round cross-sections of FIGS. 2-8 may facilitate sealing the conduits 34a and 34b and lead to durable, robust seals with respect to thermal cycling. Utilizing the rectangular cross-sections of FIG. 1 may desirably reduce the amount of material in the repeater unit 22.

The conduits 34a and 34b may include other cross-sectional geometries. Regardless the chosen geometry of the conduits 34a and 34b, the sum of the four conduit perimeters is smaller than the perimeter of other internally manifolded repeater units in the prior art that are sealed by dielectric materials, i.e., glass ceramics, in assembling a stack.

A wire mesh interconnect 86 is secured to the underside of the separator plate 66 by means of welding, seam welding, brazing, diffusion bonding or a combination of these. The wire mesh interconnect 86 is corrugated and defines a plurality of air channels 88 for directing air flow across cathode electrode side of the SOFCs 26 and of the repeater unit 22 through the stack assembly 14. The channels 88 are open toward the SOFCs 26 to facilitate the transport of oxygen to the cathode electrode of the SOFCs 26 for the electrochemical reaction. In this example, the corrugated wire mesh interconnect 86 has a dovetail cross-sectional profile.

The example wire mesh interconnect 86 is a compliant structure with well-defined deformation characteristics, which can be used to design the mechanical load that can be applied to the fuel cell 26. This approach facilitates adequate contact between the wire mesh interconnect 86 and the SOFCs 26 and minimal interface ohmic resistance. The approach also lessens the potential for fracturing the SOFC 26 and accommodates the dimensional variability of production repeater units 22 of large footprint area, which reduces material and fabrication costs.

The example wire mesh interconnect 86 is bonded to the cathode electrode by means of appropriate ceramic materials, such as perovskite or spinel materials. This approach lessens the ohmic resistance to electron flow and resists changes to the ohmic resistance across the wire mesh interconnect 86 and cathode electrode of the SOFC 26. This approach also indirectly lessens the mechanical load across the stack. Changes in the ohmic resistance typically arise from potential thermal stresses during thermal cycling. Minimization of the mechanical load or stress also leads to minimization of the potential for interconnect creep under the operating conditions, since creep deformation is a function of material properties and stress.

In this example, the metal alloy selected for the wire mesh interconnect 86 is a nickel-based alloy that exhibits excellent oxidation and creep resistance at the fuel cell operating temperatures of 650° C. to 900° C. thus ensuring good electrochemical performance stability and long lifetime for the fuel cell stack. The wire mesh interconnect 86 is coated with chromia-containment materials to further enhance performance stability and lifetime in some examples.

In one example, the wire mesh interconnect 86 is compliant and is bonded to one side or extended surface of the separator plate 66 while the flat wire mesh interconnects 74 are bonded to the opposite side of the separator plate 66 to form a bipolar plate. Example bonding techniques include brazing, welding, seam welding, diffusion bonding and other metal bonding methods well known in the art. The wire mesh interconnect 86, the flat wire mesh interconnect 74, and the separator plate 66 are made from different metals or alloys to provide enhanced oxidation, corrosion, and creep resistance and mitigation of thermal stresses that may arise during thermal cycling.

The example flat wire mesh interconnect 74 is made of a nickel based alloy, such as Haynes 230, which has excellent oxidation and creep resistance in air at the fuel cell operating temperatures of 650° C. to 900° C., the flat wire mesh interconnects 74 is made of pure nickel wire which is very stable in the fuel environment, and the separator plate 66 is made of iron-chromium alloys that offer adequate matching of thermal expansion characteristics to those of the ceramic fuel cells to ensure the integrity of the fuel cell stack under thermal cycling between the ambient and fuel cell operating temperatures.

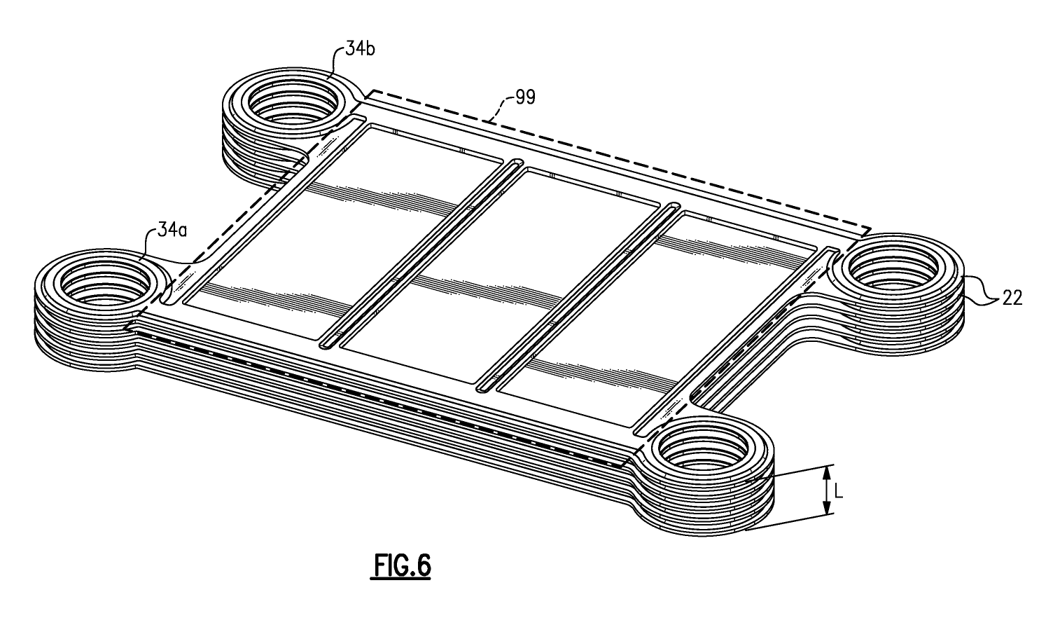

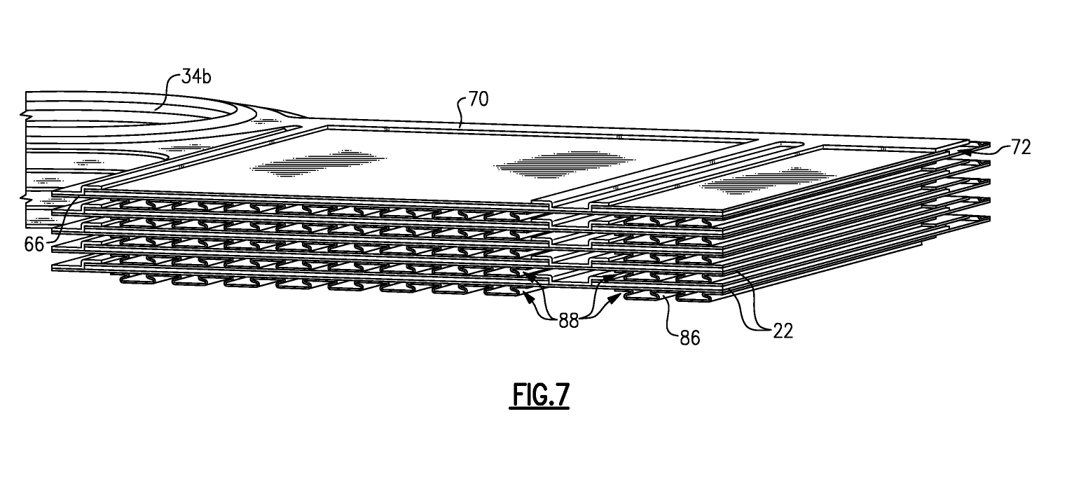

Referring now to FIGS. 6 and 7, stacking a plurality of repeater units 22 with another repeater unit 22 establishes a length L of the conduits 34a and 34b. Fuel is distributed from the conduits 34a through the space 98 in the inserts 94 into the fuel channels 72 to the SOFCs 26.

Each repeater unit 22 establishes a fuel channel perimeter 99 that surrounds all of the SOFCs 26 within that repeater unit 22. In this example, the fuel channels 72 upstream, with regard to the direction of fuel flow, and downstream of the SOFCs 26 are positioned within the fuel channel perimeter 99. That is, perimeter surrounds all of the fuel flow in a direction aligned with the SOFCs 26. The conduits 34a and 34b are positioned outside the fuel channel perimeter 99. The fuel channel perimeter 99 is aligned with the openings 98 in this example, which establish the transition from the channels 34a and 34b to the fuel channels 72 adjacent the SOFCs 26 of the repeater unit 22. The dimensions (the width and height) of the fuel channels 72 are designed so as to ensure essentially uniform flow distribution across the fuel cells 26 in each repeater unit 22 of a fuel cell 14.

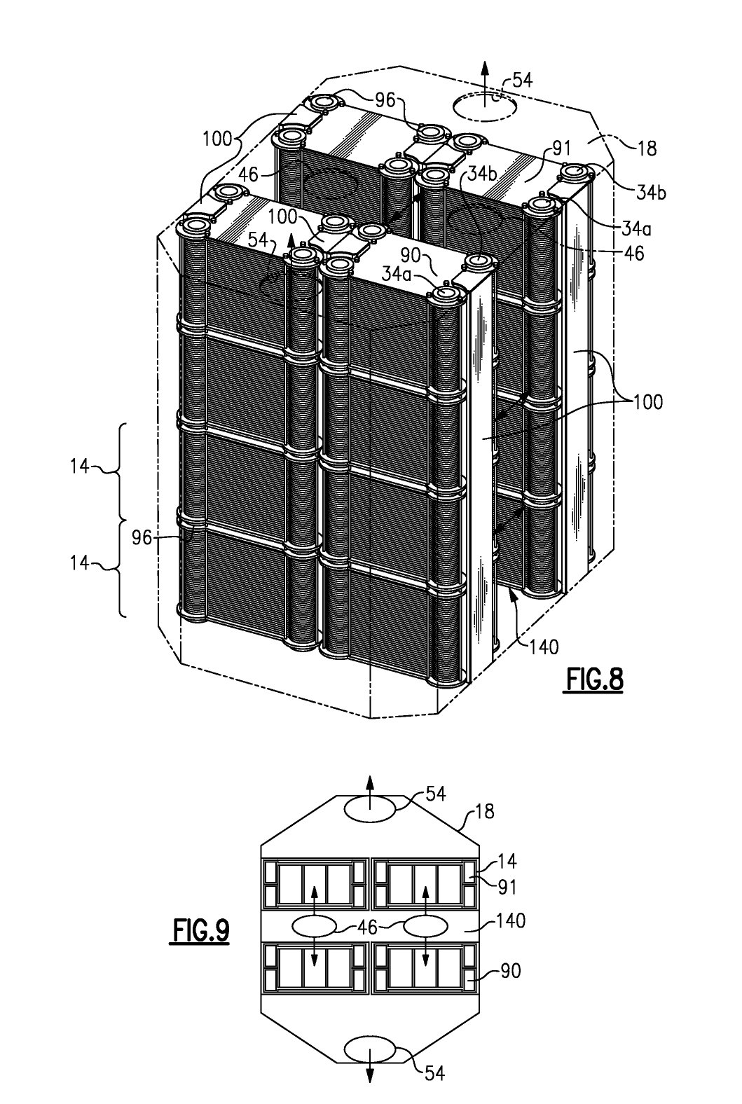

Referring now to FIGS. 8 and 9, more than one fuel cell stack assembly 14 may be arranged within a duct 18. In this example, air enters in the compartment or plenum 140 between the first group 90 of fuel cell stack assemblies 14 and second group 91 of fuel cell stack assemblies 14 and splits into two streams flowing in opposite directions, one stream moving through the channels 88 of a first group 90 of fuel cell stack assemblies 14 before exiting the duct 18, and the other stream moving through a second group 91 of fuel cell stack assemblies 14 before exiting the duct 18.

Ring seals 96 seal the interfaces between the conduits 34a and 34b of adjacent ones of the cell stack assemblies 14. The fuel cell stack assemblies 14 are packed in the duct 18 using air seals 100 configured to seal interfaces between the fuel cell stack assemblies 14 and the duct 18. The air seals 100 are made of ceramic fibrous materials that are used to provide flow resistance and essentially block air flow around the fuel cell stack assemblies 14 and in areas other than channels 88.

In one example, the conduits 34a and 34b attach to pipes (not shown) that carry fuel from the fuel supply reservoir 30 to the conduits 34a and from the conduits 34b to the spent fuel reservoir 38 or to corresponding connection points in a fuel cell system (not shown). The air inlet 46 and the air outlet 54 also attach to pipes (not shown) that carry air from the air supply 44 to the duct 18, and to the spent air reservoir 56. A person skilled in the art that has the benefit of this disclosure would understand how to suitably connect the fuel cell arrangement 10 to the fuel supply reservoir 30, the spent fuel reservoir 38, the air supply 44, and the spent air reservoir 56.

Manipulating the positions of the conduits 34a and 34b and the fuel channels 72 relative to the direction of air flow through the fuel cell stack assembly 14 provides several configurations, such as a co-flow arrangement where the fuel flows in the same direction as the air, counter-flow arrangement where the fuel flows in an opposite direction from the air, or cross-flow configurations where the fuel flows transverse to the air.

Features of the disclosed examples include an arrangement that facilitates essentially uniform distribution of fuel to individual SOFCs, which is important to the overall performance and operation of the fuel cell. Another aspect of the disclosed example involves a simplified approach to air and fuel delivery to positions adjacent the tri-layer cell. For example, positioning the conduits 34a and 34b outside of the fuel channel perimeter 99 facilitates even distribution of the air stream to the SOFCs 26. Further, positioning the conduits 34a and 34b provides a relatively open path for airflow through the fuel cell stack assemblies 14.

Other features of the disclosed examples include a fuel cell repeater unit that holds multiple SOFCs within the same plane and air distribution to the fuel cell repeater units without the use of internal manifolds or externally clamped manifolds or metering orifices. Hermetically sealing the repeater units and conduits eliminates the need for internal air manifolds. Similarly, the duct 18 eliminates external clamped manifolds. Essentially uniform air distribution is achieved with a simpler design, which reduces material and fabrication costs, and improves fuel cell stack reliability.

Other features of the disclosed examples include lessening the required lengths of the glass or glass-ceramics materials and/or the metal to dielectric skin sealing materials due to the conduits, which improves the robustness of the seals. The sealing materials are the materials that bond one side of the seal 92 to the underside of the separator plate 66 corresponding to the adjacent repeater unit 22 within the stack. Irrespective of the actual round or rectangular geometry of the conduits 34a and 34b, the sum of the four conduit perimeters is much smaller than the perimeter of a corresponding repeater unit of internally manifolded stacks that would have to be sealed by dielectric materials, i.e., glass or glass-ceramics, in assembling a stack. Minimizing the length of these seals by using the conduit embodiment of this application directly affects and improves the robustness of the sealing materials for the conduit 34a and 34b seals. The glass or glass-ceramics seal materials are materials of low strength and low fracture toughness and are vulnerable to fracture by thermal stresses arising over the course of thermal cycling from the operating temperature to ambient temperature and substantially shorter seal lengths significantly improve the likelihood of survival over thermal cycling. Moreover, using shorter length of glass or glass-ceramics seals enhances the likelihood of achieving closed-porosity seals during the stack assembly and stack firing processes.

Although a preferred embodiment has been disclosed, a worker of ordinary skill in this art would recognize that certain modifications would come within the scope of this invention. For that reason, the following claims should be studied to determine the true scope and content of this invention.

We claim:

1. A fuel cell repeater comprising:
a separator plate; and
a frame establishing at least a portion of a flow path that is operative to communicate fuel to or from at least one fuel cell held by the frame relative to the separator plate, the flow path having a perimeter, wherein any fuel within the perimeter flows across the at least one fuel cell within a first plane,
the separator plate, the frame, or both establish at least one conduit that is positioned outside the flow path perimeter and is fluidly coupled with the flow path, wherein any fuel in the at least one conduit flows within a second, different plane, wherein the planes are nonparallel.

2. The fuel cell repeater of claim 1, wherein the second plane is transverse to the first plane.

3. The fuel cell repeater of claim 2, including an insert having an opening at an interface of the flow path and the at least one conduit, the opening establishing a path for communicating fuel between the flow path and the at least one conduit.

4. The fuel cell repeater of claim 1, wherein the at least one conduit has a circular cross section.

5. The fuel cell repeater of claim 1, including a compliant interconnector portion that establishes at least a portion of a flow path operative to communicate airflow through the fuel cell repeater unit.

6. The fuel cell repeater of claim 1, wherein a stamped portion of the frame defines the flow path.

7. The fuel cell repeater of claim 6, wherein the stamped portion of the frame establishes at least one opening corresponding to a profile of the at least one fuel cell.

8. The fuel cell repeater of claim 7, wherein the at least one conduit is arranged adjacent a corner of the opening.

9. The fuel cell repeater of claim 1, wherein the at least one fuel cell is a solid oxide fuel cell.

10. The fuel cell repeater of claim 1, wherein the fuel cell repeater is securable adjacent another fuel cell repeater to increase a length of the at least one conduit.

11. The fuel cell repeater of claim 1, wherein the separator plate is welded to the frame to seal fuel within the fuel flow path, and the perimeter surrounds all of the fuel within the fuel flow path.

12. The fuel cell repeater of claim 1, wherein the conduits establish a primary fuel manifold and the flow path establishes a secondary fuel manifold.

13. A fuel cell stack assembly comprising:
at least one fuel cell repeater that establishes a plurality of fuel flow paths for communicating fuel to a position adjacent at least one fuel cell; and
a duct housing the at least one fuel cell repeater, the duct configured to guide airflow through the at least one fuel cell repeater.

14. The fuel cell stack assembly of claim 13, wherein the at least one fuel cell repeater defines a fuel inlet conduit and a fuel outlet conduit in fluid communication with the fuel flow paths.

15. The fuel cell stack assembly of claim 14, wherein the fuel flow paths are configured to direct fluid in a first direction, and the fuel inlet conduit and the fuel outlet conduit are configured to direct fluid in a second direction transverse the first direction.

16. The fuel cell stack assembly of claim 14, wherein the fuel inlet conduit and the fuel outlet conduit are further from any portion of the at least one fuel cell than the plurality of fuel flow paths.

17. The fuel cell stack assembly of claim 13, wherein the at least one fuel cell repeater comprises a separator plate and a frame that holds at least one fuel cell in a desired position relative to the separator plate.

18. The fuel cell stack assembly of claim 13, wherein the duct comprises an air inlet and an air outlet.

19. The fuel cell stack assembly of claim 18, wherein the air inlet is on a first side of the at least one fuel cell repeater, and the air outlet is on a second, opposite side of the at least one fuel cell repeater.

20. The fuel cell stack assembly of claim 13, wherein the at least one repeater includes a plurality of fuel cells aligned within the same plane.
